(19) United States
(12) Patent Application Publication
(10) Pub. No.: US 2006/0014453 A1
(43) Pub. Date: Jan. 19, 2006

(54) Flexible sign substrate with black in back

(76) Inventors: Maria L. Maia, Seekonk, MA (US); Bryan W. Rose, Warwick, RI (US); Peter S. Burnett, Cohasset, MA (US)

Correspondence Address: DOUGHERTY CLEMENTS, 1901 ROXBOROUGH ROAD, SUITE 300, CHARLOTTE, NC, 28211, US

(21) Appl. No.: 10/891,392

(22) Filed: Jul. 14, 2004

(51) Int. Cl. D04B 21/00; D03D 9/00; G09F 7/00; B32B 27/12; D04G 1/00

(52) U.S. Cl. 442/41; 442/1; 40/584; 442/38

(57) ABSTRACT

The invention is a black-in-back backlit sign substrate that has an eradicable ink. The substrate is constructed of a scrim coated on the front-side and back-side with an extruded translucent PVC, and a back-side coating of an eradicable ink. The scrim is a polyester yarn having a count of 12×12 to 20×20, with a more preferable count of 18×15 to 18×18. The weight of the backlit sign substrate is in the range of 14 to 28 oz./sq yd, with a nominal weight of about 16 oz/sq yd for the 18×15 scrim and about 24 oz/sq yd for the 18×18 scrim. The tensile strength of the 18×18 scrim sign substrate is about 270 lbs/in in the warp direction and about 220 lbs/in in the fill direction. Overall, the weight of the front-side coating is preferably slightly heavier than the back-side coating to ensure that the face of the sign is very smooth. The substrate is calendered to enhance smoothness, reduce coating profile imperfections, or to add embossing. The eradicable ink is applied as a solvent borne coating using an applicator such as a gravure roll or rotary screen, such as a Stork coater. A coating thickness of less than 0.5 mils is desired. The preferred eradicable ink is jet black, compounded to have good resistance to weather; in particular, UV radiation, resistance to cracking, crazing, and resistance to mildew and fungi in general. The sign substrate can, optionally, be front-side coated with a substantially clear acrylic topcoat, compounded to filter out UV radiation, and enhance weatherability.

### FIELD OF THE INVENTION

The present invention relates generally to a flexible sign substrate, and more particularly to a backlit sign substrate.

### BACKGROUND OF THE INVENTION

Backlit signs and awnings are typically a vinyl coated or laminated fabric substrate constructed of a translucent panel that is stretched about a metal framework, and have a light source placed on the side opposite the side being viewed. By selectively printing opaque regions on the translucent panel, words or graphics may be formed as regions having a translucent back drop. The overall effect is a neon-like lighted sign, which may be viewed during the day and at night.

Commonly, the vinyl is a PVC (polyvinylchloride) film or a related PVC-based material, and the fabric is a polyester scrim that imparts reinforcement to the substrate. PVC has good, but not excellent, weathering properties, particularly to prolonged exposure to the sun and other outside elements. The composition of the PVC is selected so as to be translucent, and prior art compositions often include titania, such as titanium dioxide, which reputedly improves UV resistance. Graphic images and letters can be formed on the foreground image through the application of a pressure sensitive decorative film to portions on the translucent panel to create a foreground image. A second pressure sensitive decorative film may be applied to certain other portions of the translucent panel to create a background image of a different color. Although not usually described in combination with the application of a pressure sensitive decorative film, the viewing side of the translucent panel can be printed forming the background. The weatherability of the sign substrate can reportedly be improved by applying an overlayer of PVF (i.e., polyvinyl fluoride). PVF film has excellent UV resistance. The overlayer is adhesively bonded to the viewing side. Typically, in addition to the adhesive, there is also a tie coat to improve the adhesion between the adhesive on the PVF film and the viewing side. The adhesion can also be improved by flame, plasma and corona treatment of the viewing side of the sign substrate.

It is often desired that a backlit sign appears substantially the same in the daylight as it does at night. A limiting factor is the source of, and intensity of the light. Daylight tends to be much more intense than the backlit light source, and in the daylight either the colors appear washed out with poor contrast because the colors are translucent, or if the colors are opaque, then at night, the sign is dim because there is insufficient backlit light to properly, translucently illuminate the sign. What is needed is a sign that is easy to read during the day and at night, and wherein at night, the graphics are bright and neon in appearance. A potential solution is the application of an opaque pressure sensitive vinyl (PSV) to the back-side of the sign substrate, but this a relatively expensive solution for a sign manufacturer, and requires that large panels of PSV be cut, oriented, and adhered to the substrate. The addition of the back-side PSV has the unwanted side effect of adding stiffness and non-uniformity to the flexible sign substrate. A less expensive, easier manufacturing process for the sign manufacturer is needed.

### SUMMARY OF THE INVENTION

The invention is a backlit sign substrate that is translucent, flexible, and easily fabricated to have custom graphics. The backlit sign substrate is capable of neon-like illumination, and it has excellent weathering and flame resistance properties. The backlit sign substrate is constructed of a fabric coated with a first extruded coating of a translucent PVC (polyvinylchloride) extrudate on a front-side, and a second extruded coating of translucent PVC extrudate on a back-side. The extrudate is applied as a low draw extrusion coating that is cast on a smooth steel roll, and nip pressed against the fabric producing a translucent substrate with a smooth surface. The translucent substrate is compounded with antimony trioxide, which imparts flame resistance with minimal reduction in translucency. The back-side of the translucent substrate is coated/printed with an eradicable ink. The medium for the eradicable ink is preferably an acrylic resin, and is comprised of a colorant that is selected from the group consisting of inorganic and organic dyes, pigments, and blends thereof. The ink is preferably jet black, and is substantially totally opaque, blocking out all light. The dried black ink on the back results in a backlit sign substrate that when lighted from the front is white, and when lighted from the back is black, except where the ink has been eradicated. Where eradicated, the color of the backlit sign substrate is translucent white, unless it is fabricated with an over-graphic of another color, and then the backlit sign takes on the color of the over-graphic. An over-graphic is an overlaminate, or a coating, or a printing or combination thereof that is on the front-side of the backlit sign substrate. The overlaminate is typically a colored PVC adhesive coated translucent film that is adhered to the front-side. The over-graphic is visible at night as a radiant image illuminated in the color of the over-graphic. If, for instance, the over-graphic is red, it will be seen as red at night and during the day where the eradicable ink is removed from the back-side. This is because during the day, the viewer will see the red over-graphic illuminated by sun light, and at night the red over-graphic will be illuminated by the backlit light. If, however, the eradicable ink has not been removed, then at night the red over-graphic will be substantially black, because the light emanating from the backlit light is blocked, and the red over-graphic will only be illuminated by the ambient light, which will be dim compared to the backlit light. In another illustration, the coating or printing on the front-side can be selected to be either permanent or eradicable. The advantage of an eradicable ink on the front-side is that the sign manufacturer has the option of producing semi-translucent signs. In any case, the ink can be custom eradicated with high contrast and resolution, for instance, through the controlled application of solvents. The solvents can be used in combination with graphic tools such as stencils, masking films and tapes, rags, sponges, rollers, and brushes. The solvent is selected to be strongly solvating for the ink, and weakly solvating for PVC. It is anticipated that mechanical techniques can be employed to remove the eradicable ink. Examples of mechanical techniques are laser ablation, water laser ablation, ultrasonic media, and plastic media sand blasting. The front-side of the backlit sign substrate can be further comprised of a protective top-coat to further improve outdoor resistance to aging. A preferred protective top-coat is a PVC coating on the front-side (face) of the backlit sign substrate, wherein the protective top-coat is formulated to be substantially clear, and to block a high percentage of UV light. UV light is known to hasten the weathering process. The protective top-coat is preferably relatively thin, less than 0.5 mils thick so as to impart minimal incremental stiffness to the backlit sign substrate. The top-coat is applied to the front-side prior to the application of any over-graphic, such as an over-laminate, printing or coating.

### OBJECTS OF THE INVENTION

The principal object of the present invention is to provide a single-ply laminate that is a backlit sign substrate that is latently translucent, flexible, and easily fabricated to have custom graphics.

Another object is to provide a backlit sign substrate that has an eradicable ink that can be selectively removed resulting in a sign that has neon-like illumination, where the appearance of the sign can be made to look similar in day and at night, or can be fabricated so that the graphics change in color and composition.

Another object is to provide a backlit sign substrate that has 5-8 year weather resistance, excellent flame resistance properties, and resistance to mildew.

Another object is to provide a backlit sign substrate that can be customized by a sign manufacturer without the use of solvent spray inks.

Another object is to provide a backlit sign substrate that can be customized with over-graphics to add color and change the composition of the sign.

Another object is to provide a backlit sign substrate that has high tensile strength, where the tensile is greater than 150 lbs per inch in both the warp and the fill direction.

Another object is to provide a backlit sign substrate that can be relatively inexpensively fabricated by a sign manufacturer into a customized sign without the need for expensive manufacturing equipment, or the use of PSV to mask the back of the sign.

### BRIEF DESCRIPTION OF THE DRAWING

The foregoing and other objects will become more readily apparent by referring to the following detailed description and the appended drawing, in which:

FIG. 1 is a cross-section of the blank of the preferred embodiment of the invented substrate.

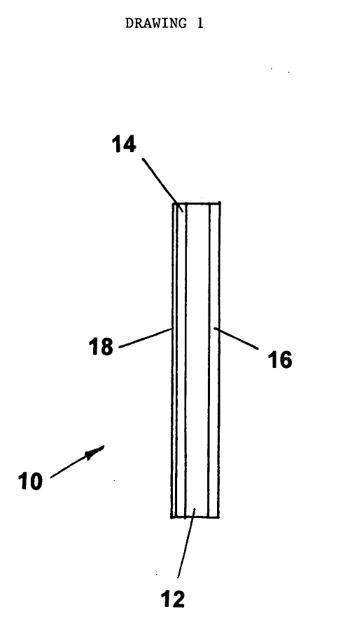

### DETAILED DESCRIPTION

The invention is a backlit sign substrate 10 that is translucent, flexible, and easily fabricated to have custom graphics. The backlit sign substrate 10 is comprised of a fabric 12, a back-side coating 14 of extruded translucent PVC, a front-side coating 16 of extruded translucent PVC, and a further back-side coating 18 of an eradicable ink. The fabric is a polyester or nylon scrim having a count of 12×12 to 20×20, with a more preferable count of 18×15 to 18×18. The fibers are typically about 500 denier, so as to produce a relatively thin scrim. The weight of a polyester scrim is 2.5 to 4.0-oz/sq. yd., with the precise weight being at least, partially, a function of the weight of the scrim. The weight of the backlit sign substrate is nominally in the range of 14 to 28 oz/sq yd, with a nominal weight of about 16 oz/sq yd for the 18×15 scrim and about 24 oz/sq yd for the 18×18 scrim. The tensile strength of the 18×18 scrim sign substrate is about 270 lbs/in in the warp direction and about 220 lbs/in in the fill direction. In a first pass, the back-side coating 14 is normally applied as a cast film on a steel roll, and annealed. In a second pass, or at a second station, the front-side coating 16 is applied as an extruded cast film, and annealed. To promote adhesion, the scrim is nominally warmed just prior to being mated with the cast translucent PVC. Overall, the weight of the front-side coating is preferably slightly heavier than the back-side coating to ensure that the face of the sign is very smooth. The coated scrim can be calendered to enhance smoothness, reduce coating profile imperfections, or to add embossing.

The eradicable ink 18 is applied as a solvent borne coating using an applicator, such as a gravure roll or rotary screen, such as a Stork coater. A coating thickness of less than 0.5 mils is desired, and a preferable thickness is about 0.3 mils. At only 0.3 mils the dried ink coating provides an opaque coating. The preferred eradicable ink is jet black, compounded to have good resistance to weather; in particular, UV radiation, resistance to cracking, crazing, and resistance to mildew and fungi in general. Optionally, a second coating of the eradicable ink can be applied to the front-side to produce special effects, such as shadowing on the sign.

The sign substrate can, optionally, be front-side coated with a substantially clear acrylic topcoat, compounded to filter out UV radiation, and enhance weatherability. Accelerated aging tests indicate that the projected service life is 5-8 years. The clear acrylic topcoat is applied at around 0.3 mils thick, and is more flexible than the front-side or back-side cast translucent PVC coatings. Typically, the topcoat is applied using coating techniques employed to coat the eradicable ink that is rotary screen and gravure. In the case of rotary gravure, the mesh size is 40 to 200 mesh, which is a preferable mesh of 100 sp.

The cast translucent PVC coatings are compounded to have flame and mildew resistance. A typical composition is, by weight percent, comprised of from about 46% to about 53% PVC, from about 17% to about 24% plasticizer, from about 0% to about 17% of filler, from about 1.5% to about 10% of flame retardant, from about 1.2% of Ba—Zn to about 4% of Ba—Zn vinyl stabilizer, from about 0.02% to about 0.1% of lubrication processing aides, and from about 0.4% to about 3% of thermal/UV stabilizer. The fillers are selected to have little opacification, and the flame retardant is preferably antimony trioxide. Other known flame retardants include aluminum trihydrate, molybdenum trioxide, and Zinc Hydroxystannate. The PVC composition has a service temperature from about −30° F. to about 200° F.

Color graphics can be added to the front-side (face) as an over-graphic. The over-graphic can be an overlaminate, for instance, 3M Scotchal® Translucent Graphic Film Series 3630 and 3632 GPS and Scotchal 3640 GPS and 3642 GPS. The overlaminate is also known as a pressure sensitive vinyl (PSV). The 3M Scotchal Translucent Graphic Film Series 3630 is a 2 mil film to produce permanent, interior or exterior graphics for internally-illuminated sign faces and awnings. It has a clear, pressure-sensitive adhesive and a synthetic liner that resists water. It is available in more than 50 colors. Alternatively, the color graphics can be coated or printed, for instance, using digital printing.

The disclosed backlit sign substrate meets both UL 48 and UL 94 requirements. UL 94 quantifies the maximum acceptable flammability of plastic materials used for parts in devices and appliances. They are intended to serve as a preliminary indication of their acceptability with respect to flammability for a particular application. The actual response to heat and flame of materials depends upon the size and form, and also on the end-use of the product using the material. Assessment of other important characteristics in the end-use application includes, but is not limited to, factors such as ease of ignition, burning rate, flame spread, fuel contribution, intensity of burning, and products of combustion. UL 48 defines the requirements for electric signs, including signs that use incandescent lamps, fluorescent lamps, HID lamps, neon tubing, and other combinations for use in accordance with the National Electrical Code, NFPA 70.

The backlit sign substrate with an eradicable ink is imaged by selectively removing the eradicable ink. This can be accomplished with a high degree of precision and at relatively low cost. The sign manufacturer prepares a reverse image masking stencil, which is typically a pressure sensitive adhesive vinyl, such as Coolmask™ or Gerber Mask I™. The masking stencil is custom cut to a stencil having the desired graphics. A pre-mask, such as TransferRite™ or R Tape, which is a low tack psa paper tape, is fastened to the release side of the masking stencil. The positive image portions of the graphic that are to be eradicated are peeled away from the pre-mask leaving the reverse negative image of the masking stencil attached to the pre-mask. The pre-mask is positioned on the back-side of the backlit sign substrate, and the masking stencil is firmly adhered to the eradicable ink. The pre-mask is removed by peeling it away from the release side of the masking-stencil at close to a 180 degree angle, therein transferring the reverse negative image to the backlit sign substrate. A solvent laden rag, preferably wetted with Cooley Magic™, which is a proprietary blend of solvents that strongly solvates the ink, and weakly solvates the underlying PVC. The eradicable ink is wiped away exposing the underlying substantially white translucent PVC, and the masking stencil is peeled off, leaving a reverse positive translucent image with sharp resolution.

The technology disclosed using a pre-mask can also be employed to precisely cut and position PSV translucent overlaminates.

Panels of the disclosed backlit sign substrate can be seamed together to make the size required for the sign or awning. Typically, the seaming is performed using radio frequency welding. Where there is a seam, if the eradicable ink is removed, the seam will be visible when the sign is backlit. The seam can be masked by the application of a stripe of white ink.

### ALTERNATIVE EMBODIMENTS OF THE INVENTION

In is anticipated that as the translucent PVC is applied as an extruded cast film, that a substantially similar embodiment would be a translucent PVC film that is laminated to the scrim. The translucent PVC film could be laminated using an extruded PVC adhesive, a pressure sensitive adhesive, a plastisol, or a heat activated adhesive. If a PVC film is employed it also could be pre-coated with the eradicable ink or the top-coat. The invented features of the disclosed backlit sign substrate do not turn exclusively on a particular sequence of fabricating the product.

### SUMMARY OF THE ACHIEVEMENT OF THE OBJECTS OF THE INVENTION

From the foregoing, it is readily apparent that we have invented a backlit sign substrate that is a single-ply laminate that is latently translucent, flexible, and easily fabricated to have custom graphics. The substrate has a black eradicable ink that can be selectively removed resulting in a sign that has neon-like illumination, where the appearance of the sign can be fabricated to exhibit the same graphics during the day and at night, or can be fabricated so that the graphics change in color and composition when backlit. The backlit sign substrate has excellent flame resistance properties, meeting both UL 48 and UL 94 specifications, weather durability of 5-8 years, wide range temperature performance from about −30° F. to about 200° F., and easy processability. A sign manufacturer can precisely eradicate the ink using pre-mask tapes and a solvent blend. No spray painting is required. The substrate is strong as well as flexible, with most grades having a tensile in excess of 200 lbs/in. The face of the substrate accepts both overlaminates, PSV, and digital printing. The backlit sign substrate can be seamed, forming substantially any size desired. The invention eliminates the need for large panels of PSV to be applied cut, oriented, and attached to the back-side of the sign.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A backlit sign substrate comprising:
a fabric;
a back-side coating of cast extruded translucent PVC;
a front-side coating of cast extruded translucent PVC; and
a back-side coating of eradicable ink on the back-side coating of cast extruded translucent PVC.

2. The backlit sign substrate, as claimed in claim 1, wherein said fabric is a scrim.

3. The backlit sign substrate, as claimed in claim 2, wherein said scrim is comprised of polyester or nylon.

4. The backlit sign substrate, as claimed in claim 2, wherein said scrim is a polyester scrim having a thread count of about 12×12 to about 20×20.

5. The backlit sign substrate, as claimed in claim 4, wherein said polyester scrim has a thread count of about 18×15 to about 18×18.

6. The backlit sign substrate, as claimed in claim 5, wherein said substrate has a total weight from about 14 oz/sq. yd. to about 28 oz/sq. yd.

7. The backlit sign substrate, as claimed in claim 6, wherein said front-side coating of cast extruded translucent PVC is heavier than the back-side coating of cast extruded translucent PVC.

8. The backlit sign substrate, as claimed in claim 1, wherein said eradicable ink is applied as a solvent borne coating using an applicator such as a gravure roll or rotary screen, such as a Stork coater.

9. The backlit sign substrate, as claimed in claim 8, wherein said eradicable ink is black.

10. The backlit sign substrate, as claimed in claim 9, wherein said eradicable ink has a dried coating thickness of less than 0.5 mils and is an opaque coating.

11. A backlit sign substrate according to claim 1, further comprising a topcoat on the front-side of the substrate.

12. The backlit sign substrate, as claimed in claim 11, wherein said topcoat is a clear acrylic topcoat.

13. The backlit sign substrate, as claimed in claim 12, wherein said topcoat has a dried thickness of less than 0.5 mils, and a nominal thickness of about 0.3 mils.

14. The backlit sign substrate, as claimed in claim 11, wherein said topcoat is applied as a solvent borne coating using an applicator such as a gravure roll or rotary screen, such as a Stork coater.

15. The backlit sign substrate, as claimed in claim 1, wherein said back-side coating of cast extruded translucent PVC is applied to the fabric prior to the application of said front-side coating of cast extruded translucent PVC.

16. The backlit sign substrate, as claimed in claim 15, wherein following the application of extruded translucent PVC, the coating is annealed.

17. The backlit sign substrate, as claimed in claim 16, wherein the substrate is calendered.

18. A backlit sign substrate according to claim 1, further comprising a front-side coating of eradicable ink on the front-side coating of cast extruded translucent PVC.

19. A backlit sign substrate according to claim 11, further comprising a front-side coating of eradicable ink on the topcoat of cast extruded translucent PVC.

20. The backlit sign substrate, as claimed in claim 1, wherein said front-side coating of cast extruded translucent PVC is selected to have good receptivity of digitally printed inks and good adhesion to overlaminates, such as pressure sensitive vinyls (PSV) that are translucent films, where PSV translucent films are applied to the face of the backlit sign substrate therein creating graphical images on the face of the sign or awning.

21. The backlit sign substrate, as claimed in claim 1, wherein said back-side coating of eradicable ink is removed using mechanical ablation techniques, as exemplified by laser ablation, water laser ablation, ultrasonic media, and plastic media sand blasting.

22. A method for processing a backlit sign substrate having an eradicable ink, said method comprising:
cutting a masking stencil, which is typically a pressure sensitive adhesive vinyl, such that the resulting image is a reverse of the image to be formed on the front-side of a sign;
laminating a pre-mask, which is a low tack psa tape, to a non-adhesive side of the masking stencil;
removing all positive image portions of the masking stencil, and leaving the reverse negative image of the masking stencil attached to the pre-mask;
positioning the pre-mask on the back-side of the backlit sign substrate;
adhering the masking stencil firmly to the eradicable ink;
removing the pre-mask, leaving the masking stencil, by peeling the pre-mask away from the masking-stencil, therein transferring the reverse negative image to the backlit sign substrate;
wiping off the eradicable ink with a rag wetted with a solvent, therein exposing the underlying substantially white translucent PVC;
peeling off the masking stencil leaving the underlying eradicable ink in tact, and creating a reverse positive translucent image with sharp resolution.

23. A backlit sign substrate comprising:
a fabric;
a back-side adhesively laminated film of cast extruded translucent PVC;
a front-side coating of cast extruded translucent PVC; and
a back-side coating of eradicable ink on the adhesively laminated film of cast extruded translucent PVC.
